(19) United States
(12) Patent Application Publication
(10) Pub. No.: US 2025/0172416 A1
(43) Pub. Date: May 29, 2025

(54) SIGNAL PROCESSING METHODS FOR AN OPTICAL DETECTION SYSTEM

(71) Applicant: SINTELA LIMITED, Bristol (GB)

(72) Inventor: Stuart Russell, Bristol (GB)

(73) Assignee: SINTELA LIMITED, Bristol (GB)

(21) Appl. No.: 18/838,709

(22) PCT Filed: Feb. 23, 2023
(86) PCT No.: PCT/EP2023/054588

§ 371 Date: Aug. 15, 2024

(30) Foreign Application Priority Data
Mar. 2, 2022 (GB) 2202909.4

(51) Int. Cl. G01D 5/353; G01H 9/00

(52) U.S. Cl. CPC G01D 5/35361; G01H 9/004

(57) ABSTRACT

The present disclosure relates to signal processing methods for an optical detection system, and systems for carrying out such processing. In particular, disclosed is a signal processing method for filtering the phase of an input signal, the method includes: receiving an input signal; applying an N-stage delay line to the input signal to generate a plurality of delayed signals, where N is an integer which may refer to the order of the filter, the value of which may be preselected to provide a desired balance between performance and processing power (as higher order filters may produce better results at the cost of increased processing power); applying a respective exponentiation to each delayed signal to generate a plurality of phase modified signals; and cumulatively multiplying each of the phase modified signals to generate a filtered signal.

### TECHNICAL FIELD

The present invention relates to signal processing methods for an optical detection system, and systems for carrying out such processing.

### BACKGROUND TO THE INVENTION

Distributed Acoustic Sensing (DAS) is an established technology with several commercial systems available. In these systems, a pulse or pulses of laser light are launched into a length of optical fiber and the light that is scattered within the fiber is analysed in order to derive the nature of the acoustic environment, i.e. any physical vibrations, of the fiber transducer. In particular, these systems typically make a measurement of the acoustic strain environment of an optical fiber transducer using an optical time domain reflectometer (OTDR) approach. This gives a differential strain measurement as a function of position along the optical fiber.

As an optical fiber is manufactured it is cooled or quenched from a high temperature as it is drawn. This process leads to the presence of small variations in the density of the optical fibre. These tiny variations in density equate to variations in the effective refractive index of the fiber. These discontinuities lead to scattering of laser light passing through the optical fiber, particularly by Rayleigh scattering. The amplitude of the scattering follows a Rayleigh distribution, but the phase angle of the scattering is uniformly distributed around a unit circle, i.e. −π≤Φ≤π where Φ is the phase angle.

For a single pulse system the length of the fiber limits the pulse repetition frequency (PRF) possible, as only one laser light pulse should interrogate the fiber at a given time. Therefore, a pulse is only sent down the optical fiber when the previous pulse has had time to travel the full length of the fiber and the scattered light return to the detector. As a result, the acoustic environment at any location of the fiber can only be sampled at the PRF and this sets an inherent limit on the maximum acoustic frequency that can be sampled with a single pulse system, related to the Nyquist limit.

Many systems only measure the amplitude of the light scattered by the fiber, which yields a result that correlates to the acoustic field only for small amplitude strains and only when correct fiber scatter bias conditions, i.e. the resulting scatter amplitude and phase as a result of the coherent sum of the scattering of light from all of the scattering sites which are illuminated at a given time, are met. For large acoustic strains or incorrect fiber scatter bias conditions these systems significantly distort the measurement of the acoustic field leading to the generation of higher frequency components which do not truly represent the amplitude or time evolution of the vibrations which are affecting the optical fiber. Systems of this nature however do give a measure of the acoustic energy and have found application for long range installations such as pipeline monitoring and borders, where detection of activity is the primary goal and a truly accurate measurement of the acoustic field is not required. Systems of this nature can be termed ‘qualitative’ systems. Operational ranges of less than 50 km, and spatial resolutions of the order of more than 20 m at these ranges are typical for such systems.

Other systems simultaneously measure the amplitude and phase of the scattered light, typically by comparing the phase of two sequential pulses or by comparing the phase of one pulse with a delayed copy of itself. In each case, said pulses are allowed to optically interfere and the resulting interference is measured. These systems yield a response which is generally linearly related to the acoustic field and the response provides a much higher dynamic range. Such systems are therefore able to represent much larger strains in the optical fiber and with much greater correlation to the acoustic field than ‘qualitative’ methods as described above. However, typically the operational range of systems of this nature is limited and therefore are targeted at shorter range applications, for example down hole seismic measurements. Systems of this nature can be termed ‘quantitative’ systems. Operational ranges of 10 km or less, and spatial resolutions of the order of 10 m are typical for such systems.

Another way of measuring the amplitude and phase of the scattered light in a ‘quantitative’ system is to use a local oscillator reference signal and measure the phase of the scattered light in relation to this reference. This method is termed coherent detection. Coherent detection has found application in communications and sensors in various forms over the past 30 years. It offers not only a coherent measurement of both phase and amplitude but also a detection noise floor much lower than direct detection methods and hence the potential for improved range and spatial resolution performance when compared to other commercial systems. However the traditional signal processing approach to employing coherent detection to build a DAS system leads to issues which limit these inherent advantages.

The present invention aims to overcome problems with known signal processing techniques applied in acoustic sensing.

### SUMMARY OF THE INVENTION

At its most general, the present invention provides a development of the signal processing methods for distributed acoustic sensing (DAS) systems set out in GB 2588177 A, which is incorporated herein by reference. In particular, the invention may enable improved filtering prior to rectangular-to-polar (RP) coordinate transformation, thus enabling improved detection of acoustic modulations along an optical path.

According to a first aspect of the present invention, there is provided a signal processing method for filtering the phase of an input signal, the method comprising: receiving an input signal; applying an N-stage delay line to the input signal to generate a plurality of delayed signals, where N is an integer which may refer to the order of the filter, the value of which may be preselected to provide a desired balance between performance and processing power (as higher order filters may produce better results at the cost of increased processing power); applying a respective exponentiation to each delayed signal to generate a plurality of phase modified signals; and cumulatively multiplying each of the phase modified signals to generate a filtered signal. By processing an input signal in this way, the method of the present invention principally acts on the phase of the input signal. As a result, the method can be used to filter phase information which is carried by the modulation of a carrier signal without crosstalk effects from the amplitude of the signal. For example, this may be particularly advantageous in distributed acoustic sensing scenarios as the amplitude information which is recovered contains information relating to the perturbation of the fibre under test. The exponent of each exponentiation step (which may be referred to as a gain coefficient) may be chosen by an operator such that the processing method performs a desired filtering function. In particular, the filtering method may advantageously be used prior to a rectangular-to-polar (RP) coordinate transformation to limit a noise demodulation bandwidth, and help to avoid overscale of the RP transform.

Optionally, the method may further comprise normalising the result of each respective exponentiation, and weighting the output of the cumulative multiplication by the initial input amplitude. In this way, the processing method presents a unity gain filter, such that the method does not distort the amplitude information received in the input signal.

Optionally, the processing method may further comprise a step of applying a rectangular to polar coordinate transform to the filtered signal. This allows instantaneous recovery of the phase and amplitude information of the filtered signal, and the performance of the transform is improved by filtering of the input signal as described above.

Optionally, wherein the input signal is a first complex carrier signal generated by receiving a real carrier signal; and applying a frequency shift to the real carrier signal to generate the first complex carrier signal. This may have the effect of ensuring that a preferred portion of the input signal is centred at DC or baseband to be acted on by the filter. For example, the input signal may be shifted by multiplying copies the signal by respective in-phase and quadrature components. In some examples, a low pass filter may be applied to the first complex carrier signal in order to select, as the input signal, a portion of the signal which has been shifted to baseband.

Optionally, the input signal may be generated by receiving a real carrier signal; applying a frequency shift to the real carrier signal, for example by multiplying the real carrier signal by in-phase and quadrature components, to generate a first complex carrier signal; generating a copy of the first complex carrier signal; applying a low pass filter to the copy of the first complex carrier signal to generate a low-pass filtered first complex carrier signal; and multiplying the first complex carrier signal with a conjugate of the low-pass filtered first complex carrier signal. For example, the real carrier signal may directly carry phase modulation information which has been received from a distributed acoustic sensing system. In certain examples, the filtered signal is multiplied with the low pass filtered complex carrier signal. By being processed in this way, phase unwrapping errors or discontinuities which may occur in the rectangular to polar coordinate transform process may be avoided. This may be particularly advantageous where the real carrier signal carries a large phase modulation. For example, in distributed acoustic sensing systems the scattered phase signal which is returned from each point along the fiber under test represents a cumulative phase up to that point. As a result, as the length of the fiber increases, the chance of such phase unwrapping errors occurring increases. This processing method is configured to help address such circumstances to improve the phase signal detection.

According to a second aspect of the present invention, there is provided a signal processing method for a distributed acoustic sensing system, the method comprising: transmitting a pulsed test signal along an optical path (which may be a fiber under test, for example); receiving, at a detector stage, a scattered signal that was scattered at a location along the optical path; receiving, at the detector stage, a local oscillator signal; generating, based on an interference of the scattered signal and the local oscillator signal, a first complex carrier signal that is modulated by a phase difference between the local oscillator signal and the scattered signal; processing the first complex carrier signal using a signal processing method according to the first aspect of the present invention. In this way, the second aspect of the present invention provides an improved distributed acoustic sensing system. In particular, the second aspect of the present invention provides a method for a distributed acoustic sensing system with an improved signal-to-noise ratio by utilising a complex filter which acts directly on the phase modulation in a linear manner without distorting the phase modulation, even in the presence of large modulation depths, where traditional processing methods would create significant distortion.

According to a third aspect of the present invention, there is provided a filter for filtering the phase of an input signal, wherein the input signal is

Input=Ae^{(iφ(t))}

where A is the amplitude and φ(t) is the phase modulation, and the action of the filter is characterised by the equation:

$$Output = {Ae}^{( i {\sum }_{k = 0}^{N} φ ( n - k ) {a}_{k} )}$$

where aₖ are the gain coefficients of the filter. In this way, the present invention may provide a filter which acts only on the phase of an input signal. As a result, the method ensures that the filter phase information is not distorted by the amplitude information and similarly that the amplitude information of the input signal may be more easily recovered as it is not distorted by the filter itself. For example, this may be particularly advantageous in distributed acoustic sensing scenarios as the phase and amplitude information which is recovered contains information relating to the perturbation of the fiber under test. The exponent of each exponentiation step (which may be referred to as a gain coefficient) may be chosen by an operator such that the processing method performs a desired filtering function. For example, the gain coefficients may be selected such that the filter is a low pass filter.

According to a fourth aspect of the present invention, there is provided a distributed acoustic sensing system comprising a filter according to the third aspect of the present invention.

### BRIEF DESCRIPTION OF THE DRAWINGS

An embodiment of the invention is discussed below in more detail with reference to the accompanying drawings, in which:

FIG. 1 is a diagram of a conventional local oscillator based optical time domain reflectometer system;

FIG. 2 shows the frequency domain of a simulated detector trace for a local oscillator based optical time domain reflectometer system as shown in FIG. 1;

FIG. 3 shows a conventional implementation of IQ filtering after digital down conversion;

FIG. 4 shows a conventional FIR filter;

FIG. 5 shows a schematic diagram of a complex filter according to an embodiment of the present invention;

FIG. 6 shows a complex filter implementing a method of the present invention;

FIG. 7 shows a comparison of the outputs of a conventional filter and a complex filtering method according to an embodiment of the present invention;

FIG. 8 shows a comparison of the outputs of a conventional filter and a complex filtering method according to an embodiment of the present invention in complex space;

FIG. 9 shows an alternative filtering arrangement implementing a filtering method according to an embodiment of the present invention; and

FIG. 10 is a chart showing the effect of the filtering arrangement of FIG. 9.

### DETAILED DESCRIPTION; FURTHER OPTIONS AND PREFERENCES

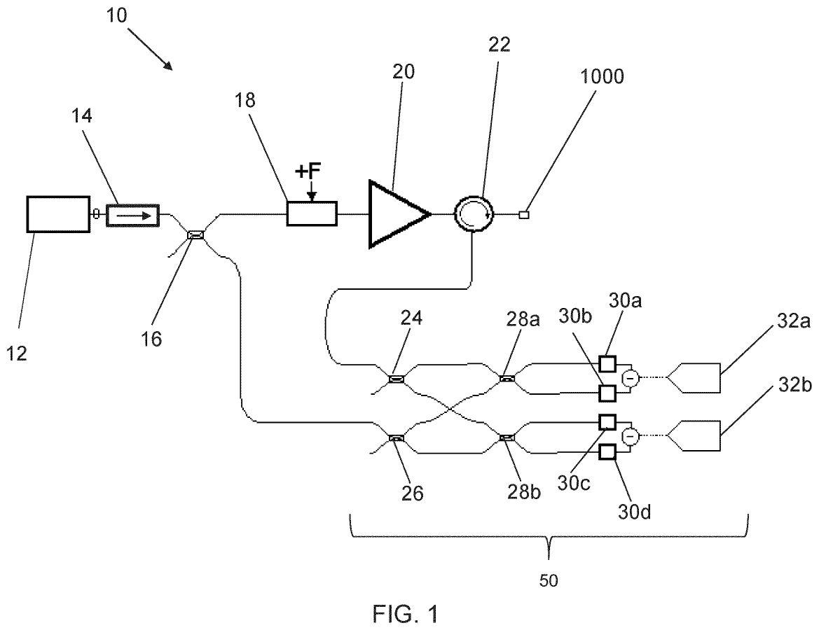

FIG. 1 shows a diagram of a distributed acoustic sensing system in the form of a local oscillator based optical time domain reflectometer (OTDR) system 10. The system 10 is arranged to interrogate an optical path, in particular an optical fiber 1000, which may be of any desirable length for a given purpose.

The system 10 comprises a light source which produces coherent light, which is given here as a laser 12, and is used in continuous wave (CW) operation. The light produced by the laser 12 is directed into an optical isolator 14 to ensure that light is not passed back to the laser 12. After passing through the isolator 14, the light is split into two paths by an optical coupler 16 or beam splitter. The first path, from which light is directed into the fiber 1000, is known as the launch path. The second path, from which light is passed directly to a detection system 50 (discussed below), is known as the local oscillator path. The light is split between the two paths by the optical coupler 16 such that 90% of the incoming light is directed into the launch path, and 10% of the incoming light is directed into the local oscillator path. Of course, the ratio of incoming light directed into each path may be chosen by the operator depending on the nature of the operation for which the OTDR system 10 is used.

The laser light which is directed into the launch path then passes through a pulse generator, such as an acousto-optic modulator (AOM) 18. The AOM 18 is a device which can simultaneously generate an optical pulse as well as upshift or downshift the frequency of light by an amount equal to the radiofrequency which drives the AOM 18. This is shown in FIG. 1 by the +F frequency being introduced to the AOM 18. This frequency, F, may be known as the intermediate frequency or the difference frequency. In this way, the AOM 18 is able to generate a pulsed test signal which may be between 5 ns and 100 ns in duration, but not limited to this range. Of course, any preferred method of generating a pulse of light may be used, such as an electro-optic modulator (EOM). The pulsed test signal may also be referred to herein as a launch pulse.

The pulse of light is then amplified using an optical amplifier 20. The amplified light pulse is introduced to the optical fiber 1000 via an optical circulator 22, which has three ports. The amplified light pulse enters the circulator 22 through a first port, where it is passed to a second port in order to enter the optical fiber 1000. As the pulse of light passes through the fiber 1000, a fraction of the light is backscattered from the fiber 1000 by Rayleigh scattering and a further fraction captured and guided back towards the circulator 22. The scattered light, which may be referred to herein as a scattered signal, enters the circulator 22 at the second port, and leaves the circulator 22 to enter a detection stage 50 via a third port.

The detection stage 50 has two inputs. The first input is the scattered laser light from the third port of the circulator 22. The second input is the laser light taken directly from the local oscillator path mentioned above. In a first part of the detection stage 50, the scattered laser light is divided into two paths, for example using a polarising beam splitter (PBS) 24. The PBS 24 splits the scattered light into a horizontally polarised state and a vertically polarised state. The PBS 24 is used as the polarisation of the pulse of light directed through the launch path and also of the scattered light will evolve as a function of distance as it passes through the optical fiber. The PBS 24 therefore ensures polarisation diverse detection, such that a signal is always detected for any polarisation state of light scattered by the optical fiber 1000. The local oscillator (LO) light, which is highly polarised, is also split equally between two paths using a polarisation maintaining optical coupler 26. In other embodiments, the LO signal may be split into two polarisation states in preference to the scattered signal as described.

The scattered light is then mixed with the LO light in each of the horizontal and vertical states at two optical couplers 28a, 28b. The light from each output of the optical couplers 28a, 28b is then allowed to interfere on a square law detector 30a, 30b, 30c, 30d. The difference of the signal from each detector pair 30a and 30b, 30c and 30d is then taken and measured at an analog-digital-converter 32a, 32b.

The system 10 described above makes use of a heterodyne sensing approach, wherein the frequency of the local oscillator and of the launch pulse are shifted relative to one another by the AOM 18. The difference in these two frequencies should be larger than the bandwidth required to represent the scattering without allowing crosstalk between the carrier and the DC terms which are also generated (see below), allowing the phase and amplitude information of the scattering to be recovered using a real carrier. Another method employs a complex carrier detection stage, replicating the polarisation diverse detection stage for two copies of the local oscillator shifted by 90 degrees relative to each other. This allows detection via a complex carrier, allowing either the positive sidelobe or the negative sidelobe of the resulting interference signal to be recovered independently. This allows homodyne operation whereby the local oscillator signal and launch pulse operate at the same optical frequency.

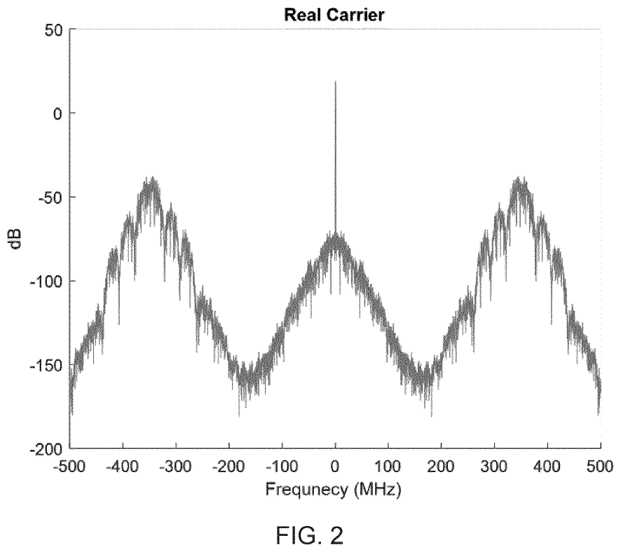

FIG. 2 is a simulated detector trace showing the detection spectrum at an analog-to-digital converter (ADC) for a local oscillator based optical time domain reflectometer system implemented with heterodyne coherent detected, as discussed above with respect to FIG. 1. Each ADC samples the input signal at a sampling rate which is of the order of ˜10⁹ samples per second. Processing within the system which occurs at this rate may be referred to herein as operating in the “ADC domain”. As this is an OTDR system, it may be considered that the ADC domain comprises a series of frames of data, wherein each frame represents a single pulse transit of the fibre under test (1000). Furthermore, each frame may be considered as comprising a fixed number of channels, with each channel representing a given fibre location. Processing which is performed on a channel-by-channel basis over several frames occurs at a reduced sampling rate which is equal to the pulse repetition frequency (PRF), and such processing may be referred to herein as operating in the “ping domain”.

In the example shown in FIG. 2, the difference frequency between the local oscillator and the launch path pulse is 350 MHZ. A treatment of the interference of two waves is given below, and the resulting terms are distinguishable in the simulated detector trace of FIG. 2. Note that for illustrative purposes a noise contribution is not included in the spectrum of FIG. 2.

A treatment of the interference of two waves for the system shown in FIG. 1 is shown below.

$${E}_{S} = \frac{1}{2} {E}_{S n} ( {e}^{i ( {ϕ}_{s n} ( t ) - {ω}_{s} t )} + {e}^{- i ( {ϕ}_{s n} ( t ) - {ω}_{s} t )} ) \qquad ( 1 )$$

Equation (1) shows the E-field resulting from scattering within the optical fiber at a position n, with phase ϕₛₙ and frequency ωₛ.

$${E}_{L O} = \frac{1}{2} {E}_{L O n} ( {e}^{i ( {ϕ}_{LOn} ( t ) - {ω}_{LO} t )} + {e}^{- i ( {ϕ}_{LOn} ( t ) - {ω}_{LO} t )} ) \qquad ( 2 )$$

Equation (2) shows the E-field of the local oscillator at a position n, with phase ϕ_{LOn} and frequency ω_{LO}.

When these two waves interfere, and are observed by a square law detector, the resulting intensity is given by equation (3), below:

$${I}_{D e t} = ( {E}_{S} + {E}_{L O} ) \cdot {( {E}_{S} + {E}_{L O} )}^{*} \qquad ( 3 )$$

This can be expanded and simplified to:

$${I}_{D e t} = \frac{1}{4} {\vert {E}_{S} \vert}^{2} + \frac{1}{4} {\vert {E}_{L O} \vert}^{2} + \text{} \frac{1}{4} \vert {E}_{s} \vert \text{} \vert {E}_{L O} \vert [ {e}^{i ( {ϕ}_{s n} ( t ) - {ϕ}_{LOn} ( t ) - ( {ω}_{s} - {ω}_{L O )} t )} + {e}^{- i ( {ϕ}_{s n} ( t ) - {ϕ}_{LOn} ( t ) - ( {ω}_{s} - {ω}_{L O )} t )} + {e}^{i ( {ϕ}_{s n} ( t ) + {ϕ}_{LOn} ( t ) - {( {ω}_{s} + {ω}_{L O )} t )}_{+}} {e}^{- i ( {ϕ}_{s n} ( t ) + {ϕ}_{LOn} ( t ) - ( {ω}_{s} + {ω}_{L O )} t )} ]$$

It can be seen that this generates a DC term related to the scattered light intensity; a DC term related to the local oscillator intensity; a negative frequency term which is centred at the difference frequency between the local oscillator and scattered light waves; and a positive frequency term which is centred at the difference frequency between the local oscillator and scattered light waves. The positive and negative frequency terms also carry information about the phase difference between the local oscillator and scattered light waves at a time, t. As a result, it is only necessary to analyse one of the positive or negative frequency terms in order to recover the phase and amplitude information, e.g. by analysing either one of the two sidebands shown in FIG. 2.

In order to recover information relating to the phase and amplitude of the signal, the signal typically undergoes digital down conversion to recover only the positive frequency term, followed by rectangular to polar coordinate transformation yielding the instantaneous phase and amplitude of the signal as a function of time. This process is equivalent to a complex multiplication and has the effect of shifting the positive frequency term, or carrier, down to DC and then filtering the signal to remove what was the DC terms and the negative frequency term. That is, the recovered signal is around the positive frequency peak shown on the right-hand side of FIG. 2. At this stage since the wanted bandwidth and hence the bandwidth of the low pass filter is less than the carrier frequency, there is in effect a complex carrier at baseband, centred at 0 Hz. In conventional arrangements, the filtered components may then be passed to a rectangular-to-polar (RP) coordinate transform, yielding the instantaneous phase and amplitude of the carrier as a function of time. However, the present invention provides an improvement to this arrangement, by utilising a complex filter prior to the RP coordinate transform, as discussed in more detail below.

In the conventional arrangement, where the RP transform is applied directly after digital down conversion, the phase recovered is the cumulative phase modulation acting on the fibre up to that position. The spatial differential of phase is calculated after the RP coordinate transform and the data from each channel can be separated and output at the PRF (i.e. in the “ping domain” as outlined above). This arrangement may be termed “phase domain processing” as the information for each channel is recovered after the RP transform, in the phase domain.

However, the capability of phase domain processing is limited. As the length of the fibre increases, the received signal will tend to reduce to a level where the noise approaches the non-linear threshold of the RP coordinate transform due to losses in the fibre. Furthermore, as noted above the phase response received is a cumulative phase and so if the rate of change of phase exceeds the demodulation bandwidth, either due to its frequency or its amplitude, then ‘overscale’ occurs, i.e. when the system can no longer track the phase and a phase jump occurs. Over a long length of fibre for typical applications the probability of cumulative phase overscale is almost certain.

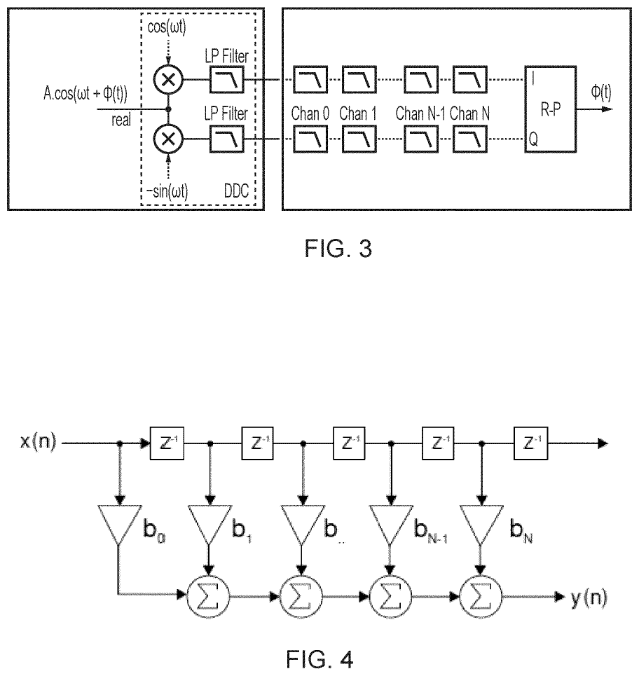

A known way to address the problems with phase domain processing is to use an IQ filter after digital down conversion but prior to RP coordinate transform, as shown in FIG. 3.

The input signal, from the ADC, is split into two branches, one branch being multiplied by an in-phase component (cos(ωt)) and the second branch being multiplied by a quadrature component (−sin(ωt)) by convention. These multiplied terms are then low pass filtered (LP Filter) in the ADC domain to remove the shifted DC and 2ω components, and so retaining only the positive frequency term. This is equivalent to a complex multiplication and has the effect of shifting the carrier frequency down to DC and then filtering it to remove what was the DC term and the negative term, as discussed above (e.g. to recover the right-hand lobe shown in FIG. 2, centred on baseband). This is digital down conversion (DDC) and, as discussed above, the DDC stage shown in FIG. 3 operates in the ADC domain (that is, the same sampling rate as the ADC from which the data is received).

After the DDC stage, a digital filter is applied to each of the real (I) and imaginary (Q) components of the complex field. This type of filtering is known as an IQ filter.

The IQ filter shown in FIG. 3 filters in the ping domain, and so independently filters each spatial channel in order to limit the noise demodulation bandwidth for each channel prior to the RP coordinate transform.

The filtered in-phase (I) and quadrature (Q) components are then passed to a rectangular-to-polar (RP) coordinate transform in order to find the instantaneous phase and amplitude of the signal as a function of time.

If the phase modulation on the carrier is small then this approach is valid and the effect is to reduce the noise in band, reduce the probability of phase unwrap errors, and improve the signal quality of the data. However, since the filtering is occurring on I and Q components independently, if the modulation depth is large the I and Q components each have higher frequency Fourier components that once filtered out not only reduce the noise in band but also lead to significant signal distortion, as shown below.

To demonstrate this, the input signal to the digital down converter of FIG. 3 may be described by

$$Input = A c o s ( {ω}_{C} t + {φ}_{m} ( t ) )$$

where ω_{c} is the carrier frequency and φₘ is the phase modulation to be recovered. The phase modulation may be described by

$${φ}_{m} ( t ) = {A}_{m} cos ( {ω}_{m} t + {φ}_{0} ( t ) )$$

where Aₘ is the phase modulation amplitude, ωₘ is the phase modulation frequency and φ₀ is the phase bias of the phase modulation.

It can be shown that the signals at I and Q for an individual channel in the ping domain are given by

$$I ( t ) = \frac{1}{2} cos ( {A}_{m} sin ( {ω}_{m t} + {φ}_{0} ( t ) ) - {φ}_{c} )$$

$$Q ( t ) = - \frac{1}{2} sin ( {A}_{m} sin ( {ω}_{m t} + {φ}_{0} ( t ) ) - {φ}_{c} )$$

where φ_{c} is the phase bias of the mix down oscillators generating the sine and cosine multiplying signals, which can be set to zero.

To demonstrate the effect when the modulation amplitude increases, these equations for I(t) and Q(t) can be expanded using the Jacobi-Anger expansions to be shown as a series of Bessel functions

$$I ( t ) = \frac{1}{2} \{ {J}_{0} ( {A}_{m} ) + {J}_{2} ( {A}_{m} ) cos ( 2 {ω}_{m} t ) + … + {J}_{∞} ( {A}_{m} ) cos ( {∞ω}_{m} t ) \}$$

$$Q ( t ) = \text{} \frac{1}{2} \text{} \{ {J}_{1} ( {A}_{m} ) cos ( {ω}_{m} t ) + {J}_{3} ( {A}_{m} ) cos ( 3 {ω}_{m} t ) + … + {J}_{∞ - 1} ( {A}_{m} ) cos ( ( ∞ - 1 ) {ω}_{m} t ) \} .$$

It will be appreciated from the expansion that the in-phase component consists of a DC offset and even harmonics of the modulation, whereas the quadrature component consists of only the odd harmonics with zero DC offset. The phase bias of the carrier and the demodulation yields an additional DC term in both I and Q, but this is not shown here. The amplitudes of the higher harmonics are related to the modulation depth (or modulation amplitude) and scale as the J₂ₙ(Aₘ) for in-phase components and J₂ₙ₋₁(Aₘ) for the quadrature components. If these higher frequency components are filtered out by the low pass filters then the recovered phase-modulated signal is a distorted form of the original phase modulated carrier, as amplitude information is lost through the filtering. As a result, for modulation frequencies of the order of the modulation bandwidth then only small modulation depths can be supported without signal distortion. The present invention addresses this problem by providing an improved signal filtering method.

An example of a conventional finite impulse response (FIR) filter is shown schematically in FIG. 4. Such an FIR filter is typically used as a low pass filter in the arrangement shown in FIG. 3.

The filter comprises a cascade of delay lines (Z⁻¹) and gain coefficients (b₀, b₁ . . . b_{N-1}, b_{N}) to form an N tap filter. A stream of real data (x(n)) is input into the filter. The first data is multiplied by the gain coefficient b₀, and the result added to the preceding data which has been delayed and multiplied by the gain coefficient b₁. This sum is then added to preceding data which has been delayed again (i.e. a total delay of Z⁻²) and multiplied by the gain coefficient b₂. This continues for the N taps and a stream of data y(n) is received as the output. It will be appreciated that any suitable number of taps, N, may be used, and this number may be chosen by a designer of the filter. N may also be referred to as the order of the filter.

The output of the filter as a function of its input may be expressed as

$$Y ( n ) = {b}_{0} X ( n ) + {b}_{1} X ( n - 1 ) + {b}_{2} X ( n - 2 ) + … + {b}_{N} X ( n - N ) ,$$

or, equivalently

$$Y ( n ) = {\sum }_{k = 0}^{N} X ( n - k ) {b}_{k} .$$

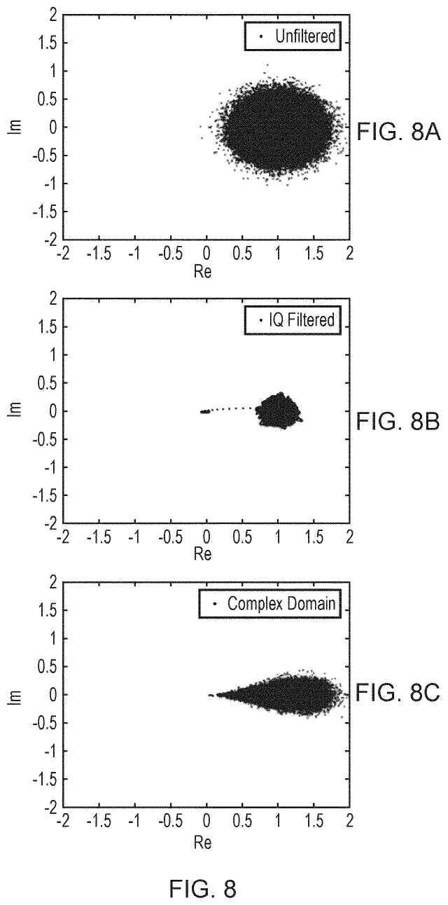

However, as discussed above, the FIR filter not only reduces the phase noise bandwidth, but also the amplitude noise bandwidth of the phase modulated carrier itself, leading to distortion. This is demonstrated in FIG. 8 as discussed below.

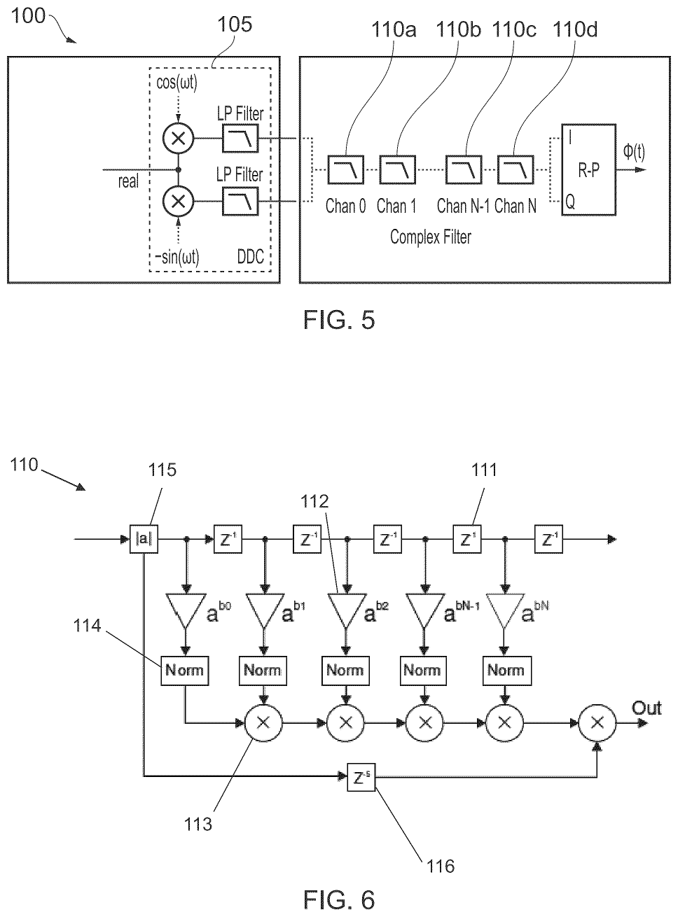

FIG. 5 shows a schematic diagram of filtering arrangement 100 comprising a digital down converter 105 and a novel complex filter, implementing a signal processing method which is an embodiment of the present invention. In particular, the complex filter comprises a series of complex filters 110a, 110b, 110c, 110d wherein each complex filter acts on an individual channel in the ping domain.

The digital down converter 105 receives the same input as discussed above with respect to FIG. 3. For example, in an OTDR system such as shown in FIG. 1, this input may be received from an analog-digital converter to perform digital acoustic sensing. The input is divided into two branches which are respectively multiplied by an in-phase component and a quadrature component. This has the effect of shifting the input signal such that the positive frequency term, or carrier, is moved down to DC, in a similar manner as discussed previously. However, rather than being fed into respective filters, the in-phase and quadrature components are recombined into a single complex signal which is passed to a series of complex filters 110a, 110b, 110c, 100d, described in more detail below, which filter the signal for each channel of the optic fibre. The output from the complex filters 110a, 110b, 110c, 110d is then passed to an RP coordinate transform 120 in order to find the instantaneous phase and amplitude of the signal as a function of time. The complex filters 110a, 110b, 110c, 110d are configured to act directly on the phase modulation in a linear manner without distorting the phase modulation, even in the presence of large modulation depths (though still less than n radians in magnitude) where conventional OQ filtering creates significant distortion, as discussed above.

FIG. 6 shows a complex filter 110 which implements a signal processing method according to the present invention. The complex filter 110 may be used, for example, as part of the filtering arrangement 100 shown in FIG. 5. In particular, the complex filter 110 may be used to filter any individual channel in the ping domain.

The complex filter 110 comprises a cascade of delay lines 111 (Z⁻¹) and gain coefficients 112 (b₀, b₁, . . . b_{N-1}, b_{N}). However, rather than multiplying the incoming delayed signal by the gain coefficient 112, the carrier is instead raised to this power by using the gain coefficient in an exponential multiplication. That is, the signal output from each delay line is a^{b}₀, a^{b}₁, . . . a^{b}_{N-1}, a^{b}_{N}. This has the effect of ensuring that the gain coefficients act only on the phase component and not on the amplitude component of the input signal. Furthermore, rather than summing the signals at each step, the signals are multiplied 113 before passing to an output, such that the filter comprises a cumulative multiplication. That is, the output is the product of each delayed signal after being acted on by the gain coefficients 112.

The complex filter 110 therefore receives an input signal, which is a complex signal, and a plurality of delayed signals are generated by the delay lines 111. As shown in FIG. 6, a respective exponentiation 112 is applied to each of the delayed signals to generate a plurality of phase modified signals, which are then cumulatively multiplied 113 to generate a filtered signal.

To ensure that the complex filter 110 does not distort the amplitude information, the filter 110 is configured to maintain a unity amplitude gain. To achieve this, each internal stage is normalised 114 to a unity vector prior to the cumulative multiplication 113. The initial input vector amplitude 115 is delayed by the group delay 116 of the filter (five taps are shown in FIG. 6, so the group delay applied to the initial input vector amplitude 115 is Z⁻⁵), and this is used to weight the output of the cumulative multiplications 113. These additional steps thereby ensure that the complex filter 110 has a unity gain in the passband to avoid distortion.

The output of the filter can be expressed by

$$Output = A {e}^{( i {\sum }_{k = 0}^{N} φ ( n - k ) {a}_{k} )} ,$$

where the input signal has the form

Input=Ae^{(iφ(t))},

where A is the amplitude and φ(t) is the phase modulation of the input, and aₖ are the gain coefficients of the filter. It will therefore be appreciated from these expressions that the amplitude, A, is maintained by the filter, and it is only the phase of the signal which is affected.

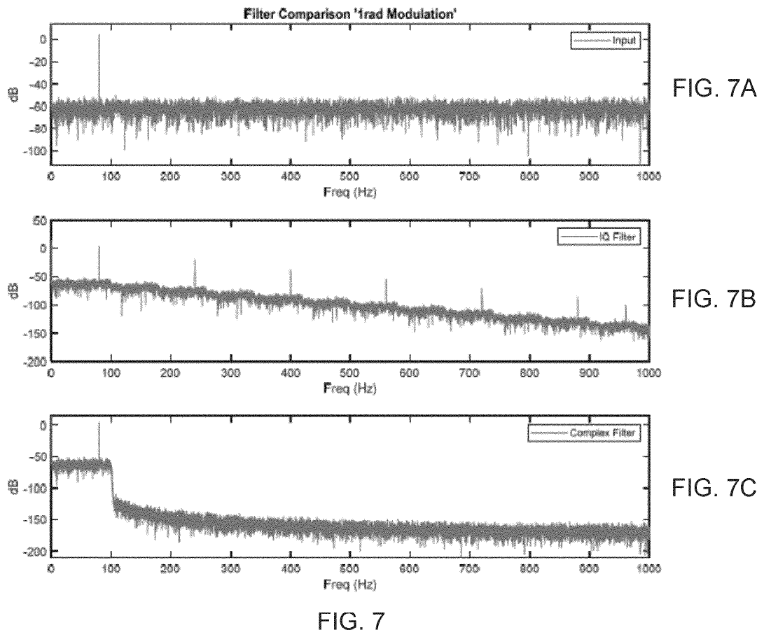

FIG. 7 shows a comparison of the outputs of a conventional IQ filter (e.g. as described above with respect to FIG. 4) and a complex filter which may be used in embodiments of the present invention (e.g. as described above with respect to FIG. 6).

FIG. 7a shows the frequency spectrum of the signal which is input to the filters. The input is a ‘noise only’ signal having a large modulation applied. In particular, the modulation is an 80 Hz modulation with an amplitude of 1 radian.

FIG. 7b shows a simulation of the output of a conventional IQ filter when the input shown in FIG. 7a is applied. It is clear that the filter is distorting the modulation signal, as a result of crosstalk effects.

FIG. 7c shows a simulation of the output of a novel complex filter which may be used in embodiments of the present invention, for example as described above with respect to FIG. 6. Contrasted with FIG. 7b, it is clear that the complex filter behaves linearly and does not distort the signal.

FIG. 8 shows the same data as FIG. 7, but the data is shown in complex space. Here it can be seen more clearly that the novel complex filter specifically filters the phase component and does not reduce the amplitude noise, whereas the conventional FIR filter acts on both the phase and amplitude of the input signal.

FIG. 8a shows the signal which is input to the filters, showing the real and imaginary parts of the phase modulated ‘noise only’ carrier signal.

FIG. 8b shows a simulation of the real and imaginary components of the output of a conventional IQ filter when the input shown in FIG. 8a is applied.

FIG. 8c shows a simulation of the real and imaginary components of the output of a complex filter which may be used in embodiments of the present invention, for example as described above with respect to FIG. 6. Contrasted with FIG. 8b, it is clear that the complex filter behaves linearly and does not distort the signal.

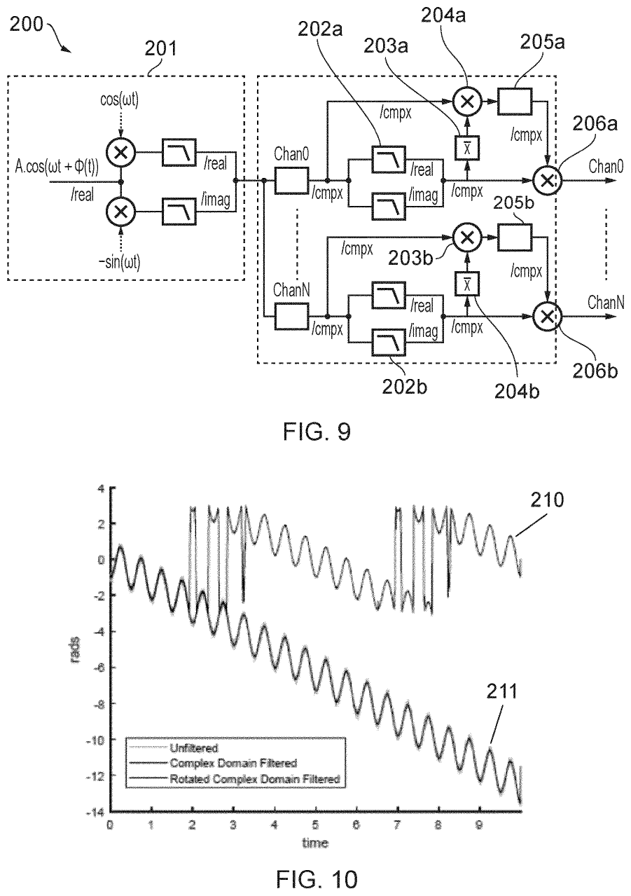

FIG. 9 shows an alternative filtering arrangement 200 for implementing another method which is an embodiment of the present invention. The filtering arrangement 200 incorporates complex filters 205a, 205b, wherein the complex filters 205a, 205b may be filters as described above with respect to FIG. 6, for example. The filtering arrangement 200 is configured to address problems which may occur when phase wrapping of the input signal may present problems. In particular, the arrangement of FIG. 9 may be useful to filter modulation depths of ±π radians in a linear manner without distortion. However, remembering that the signal received by the analogue to digital converter (see FIG. 1) is representative of a cumulative phase change, phase unwrapping may occur for large modulation depths requiring an offset of 2n to be applied to resolve ambiguity. Furthermore, as a DC bias of the carrier signal approaches the phase unwrap position the magnitude of the modulation can be significantly reduced. The filtering arrangement 200 addresses these problems.

As before, the received signal undergoes digital down conversion 201 in the adc domain. That is, the signal is split between two branches, with one part of the signal being multiplied by an in-phase component and a second part being multiplied by a quadrature component. The in-phase and quadrature components are then low-pass filtered and recombined to form a complex signal, which is downshifted compared with the original input, for example such that a peak as shown on the right hand side of FIG. 2 is centred at baseband. The received signal may be considered as a real carrier signal, and the multiplication by in-phase and quadrature components in this way generates a first complex carrier signal (the downshifted complex signal).

The downshifted complex signal which is output from the digital down converter 201, as described above, comprises a number of channels wherein each channel represents a given fibre location. Processing continues on a channel-by-channel basis in the ping domain. The signal for each channel is divided, or copied. A first part is passed to an IQ low pass filter 202a, 202b, similar to that described with respect to FIGS. 3 and 4 above. The low pass filters 202a, 202b thereby generates a low pass filtered first complex carrier signal. A portion of this IQ filtered signal is conjugated 203a, 203b and multiplied 204a, 204b with the previously-obtained downshifted complex signal. This multiplication has the effect of removing a bias of the signal within the bandwidth of the low pass filters, such that an output of the multiplication includes only high frequency components of the original input.

The result of the multiplication step 204a, 204b is passed into a complex filter 205a, 205b. For example, the complex filter 205a, 205b may be a complex filter as described above with respect to FIG. 6. As described above, this complex filter 205a, 205b maintains phase amplitude information in the signal.

Finally, the output of the complex filter 205a, 205b is multiplied 206a, 206b with the non-conjugated output of the IQ low pass filter 202a, 202b, i.e. the low pass filtered first complex carrier signal. The overall output can then be passed to an RP conversion step in order to recover the instantaneous phase information.

The filter 200 thereby converts a wrapped phase signal into a continuous phase signal, i.e. without 2n jumps in the signal, as shown in FIG. 10. The action of this filter 200 is to in effect rotate the complex carrier to the zero phase bias position, allowing a complex filter to be actioned on the rotated zero biased carrier and then to re-rotate the complex filtered output back to its bias position, allowing slow DC drift that would otherwise impair the function of the complex filter.

FIG. 10 is a chart showing the effect of the filtering arrangement 200 discussed above with respect to FIG. 9. Two graphs are plotted in FIG. 10. A first graph 210 shows the response of a complex domain filter (e.g. the filter described above with respect to FIG. 6), and a second graph 211 shows the response of the filter 200 shown in FIG. 9. In each case, the input data where a bias angle increases linearly from 0 to 4π. It is apparently from FIG. 10 that as the bias approaches (2n−1)π, where n is an integer, the complex domain filter fails as there is no intrinsic phase unwrap, resulting in the jumps and discontinuities in graph 210. In contrast, the filtering arrangement 200 linearly outputs the bias response across the whole range, and so there are no unwrap errors or discontinuities in graph 211.

Each feature disclosed in this specification (including any accompanying claims, abstract and drawings) may be replaced by alternative features serving the same, equivalent or similar purposes, unless expressly stated otherwise. Thus, unless expressly stated otherwise, each feature disclose is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A signal processing method for filtering the phase of an input signal, the method comprising:
receiving an input signal;
applying an N-stage delay line to the input signal to generate a plurality of delayed signals;
applying a respective exponentiation to each delayed signal to generate a plurality of phase modified signals; and
cumulatively multiplying each of the phase modified signals to generate a filtered signal.

2. The method of claim 1, further comprising:
normalising the result of each respective exponentiation; and
weighting the output of the cumulative multiplication by the initial input amplitude.

3. The method of claim 1, further comprising applying a rectangular to polar coordinate transform to the filtered signal.

4. The method of claim 1, wherein the input signal is a first complex carrier signal generated by: receiving a real carrier signal; and further comprising:
applying a frequency shift to the real carrier signal to generate the first complex carrier signal.

5. The method of claim 4, wherein the input signal is a low pass filtered complex carrier signal generated by applying a low pass filter to the first complex carrier signal.

6. The method of claim 1, wherein the input signal is generated by:
receiving a real carrier signal;
applying a frequency shift to the real carrier signal to generate a first complex carrier signal;
generating a copy of the first complex carrier signal;
applying a low pass filter to the copy of the first complex carrier signal to generate a low pass filtered first complex carrier signal; and
multiplying the first complex carrier signal with a conjugate of the low pass filtered first complex carrier signal.

7. The method of claim 5, wherein the filtered signal is multiplied with the low pass filtered complex carrier signal.

8. A signal processing method for a distributed acoustic sensing system, the method comprising:
transmitting a pulsed test signal along an optical path;
receiving, at a detector stage, a scattered signal that was scattered at a location along the optical path;
receiving, at the detector stage, a local oscillator signal;
generating, based on an interference of the scattered signal and the local oscillator signal, a first complex carrier signal that is modulated by a phase difference between the local oscillator signal and the scattered signal; and
processing the first complex carrier signal using the signal processing method of claim 1.

9. A filter for filtering the phase of an input signal, wherein the input signal is
Input=Ae^{(iφ(t))}
where A is the amplitude and φ(t) is the phase modulation, comprising a filter configured to act upon the input signal according to the equation:
$$Output = A {e}^{( i {\sum }_{k = 0}^{N} φ ( n - k ) {a}_{k} )}$$
where aₖ are the gain coefficients of the filter.

10. A distributed acoustic sensing system comprising a filter according to claim 9.
